(19) United States
(12) Patent Application Publication
(10) Pub. No.: US 2024/0263680 A1
(43) Pub. Date: Aug. 8, 2024

(54) GAS PERMEABLE MATERIAL IN AN AIR SPRING

(71) Applicant: CARBON AIR LIMITED, Manchester (GB)

(72) Inventors: John Fitzgerald COAKLEY, Manchester (GB); James MASSAGLIA, Manchester (GB)

(73) Assignee: CARBON AIR LIMITED, Manchester, EN (GB)

(21) Appl. No.: 18/261,758

(22) PCT Filed: Jan. 18, 2022
(86) PCT No.: PCT/GB2022/050139

§ 371 Date: Jul. 17, 2023

(30) Foreign Application Priority Data
Jan. 18, 2021 (GB) 2100634.1
Mar. 17, 2021 (GB) 2103728.8

(51) Int. Cl. F16F 9/04; B60G 15/12; F16F 9/05

(52) U.S. Cl. CPC F16F 9/0472; F16F 9/05; B60G 15/12; B60G 2202/30; B60G 2204/61; B60G 2206/42; B60G 2800/162; F16F 2222/126; F16F 2224/02; F16F 2224/0225; F16F 2224/0266; F16F 2228/007

(57) ABSTRACT

The invention relates to an air spring for supporting a load, the air spring comprising: a chamber for holding a pressurised gas in use; a load bearing surface arranged to transmit a force from a load in use to the pressurised gas, and a block of gas permeable resilient material contained in the chamber. Uses of a block of gas permeable resilient material are also disclosed.

### CROSS-REFERENCE TO RELATED APPLICATIONS

This application is a national-stage of PCT/GB2022/050139, filed Jan. 18, 2022, which claims priority to GB 2100634.1, filed Jan. 18, 2021, and GB 2103728.8, filed Mar. 17, 2021.

### FIELD OF THE INVENTION

The present invention relates to improvements in air springs, and most specifically to air springs for use in vehicular or industrial applications to support a load.

### BACKGROUND OF THE INVENTION

Air springs were developed by Firestone (RTM) in the late 1930s as a more efficient spring, or vibration isolator for use in vehicular suspension systems. See for example U.S. Pat. No. 2,208,537 which is incorporated herein by reference. Today, almost all buses and many trucks and trailers now ride on air springs. Air springs are also becoming more common in automotive applications, mountain bikes, motorbikes, and in industrial applications as well.

A typical air spring comprises an upper bead plate, bellows and a piston. A first chamber is generally within the bellows and has a dynamic volume that changes in use. A second chamber is generally within the piston and has a fixed volume in use. Fluid communication between the dynamic volume and the fixed volume can be unrestricted or may be restricted, with the latter achieved, typically by a divider such as a lid comprising one or more orifices to provide damping by air resistance (see for example US 2012/0061887 A1 which is incorporated herein by reference).

In the automotive sector, electrical vehicles that are being developed seek the use of air suspension systems because of its self-levelling characteristics. Such a characteristic is advantageous in an electrical vehicle because it protects the valuable, battery-laded underfloor of the vehicle from hitting the road surface in use as it rides over uneven surfaces. The same characteristic also allows for optimised aerodynamic efficiency at motorway speeds by lowering ride height and tilting the vehicle forward slightly. This is critical for the maximising of electric range.

One disadvantage of such systems is that the components used in the air spring are typically quite bulky and heavy, which is clearly not ideal in an electrical vehicle where low weight and size are of crucial importance to maximising performance. Furthermore, if the volume size of the air spring is reduced, then the spring rate (i.e. the amount of force required to compress a spring a set distance) increases, which results in an unacceptably hard spring and makes the ride of the vehicle uncomfortable for passengers.

Air springs may also comprise internal damping without the use of an external hydraulic damper. This is achieved by restricting the air flow between the dynamic volume and the fixed volume using a plate comprising a wall with one or more orifices therein as discussed above. The internal damping force that is generated in this regard is strongly rated to the ratio between the dynamic volume and the fixed volume of the air spring. For example, a small fixed volume will mean that only a small amount of air from the dynamic volume to the fixed volume will be forced through the orifices by the movement of the spring in use because the stiffness of the air in the fixed volume will be high. Therefore, the fixed volume is often made as large as possible to retain an acceptable spring rate. However, the use of a bulky and heavy fixed volume chamber is not ideal as vehicles strive to become lighter and more efficient.

The use of a mass of adsorbent (adsorptive) material (such as activated carbon) to lower the spring rate of an air spring has been disclosed in WO 2012/052776 A1. Such a material can be used to achieve a desired reduction in the spring rate and improve vibration isolation. Therefore, for a given purpose, a much smaller air spring containing an adsorbent material may be used while achieving the same vibration isolation and spring rate as a larger spring without an adsorbent material.

The use of a mass of adsorbent material has also been disclosed in WO 2012/052776 A1 to increase the damping effect within an air spring when used in combination with a damping plate comprising one or more narrow orifices. The increased damping effect arises from the large uptake of gas in the adsorbent material (through adsorption/desorption) contained in the fixed volume behind the damping plate comprising one or more orifices.

Whilst it could be envisaged from the disclosure of WO 2012/052776 A1 that the fixed volume could now be made smaller, such an arrangement is not without its problems.

Although an adsorbent material contained in the fixed volume will provide more accommodation for gas, the adsorbent material contained in the fixed volume will have less of an effect or even no effect to reduce the spring rate in the dynamic volume because the gas passing from the dynamic volume to the fixed volume, will be choked by the damping plate. Consequently, the spring rate in the dynamic volume will still remain high, particularly above a certain transition frequency, and could only be lowered by the use of larger dynamic volume, which as discussed, is not ideal as vehicles strive to become lighter and more efficient.

One might assume that a solution to such a problem could be to provide the adsorbent material (such as activated carbon) to the dynamic volume to reduce its size. However, the adsorbent material cannot be used in the dynamic volume since the material is not compressible, and is therefore incompatible with the dynamic volume as the spring is in use.

A further problem is that adsorbent material (such as a loose carbon granules) which is either provided initially in loose form or becomes loose in use is undesirable in an air spring. This is because any loose debris (such as fine power) caused by the granules colliding and grinding against each other during vibration may lead to the air supply lines and/or damping orifices becoming clogged.

The Applicant has developed monoliths of carbon to overcome such problems (see for example WO 2020/008072 A1 which is incorporated herein by reference). However, such monoliths of carbon do not provide a solution to reducing the size of the dynamic volume as discussed above.

US 2004/0100005 A1 discloses the use of a fibrous heat sink material in the working chamber of an air spring in order to reduce the spring rate. “Quallofil®” is an exemplified fibrous material and is uniformly distributed within the working chamber. However, the Applicant has found that uniformly distributing such fibrous material across the full extent of the working chamber of an air spring is highly disadvantageous because the material will contact the walls of the working chamber as shown in FIG. 2 of US 2004/0100005 A1. This contact results in surface friction between the fibrous heat sink material and the walls of the air spring, and consequently increases the risk of a leakage arising from such damage by friction.

Whilst a friction reducing coating such as PTFE may be added to the fibrous material to overcome such problems, this causes an increased cost and complexity to the manufacturing process of the air spring. Therefore, it is highly advantageous to provide a material for use in an air spring that will not result in damage to the walls of a working chamber.

Furthermore, to overcome the undesirable effects of the use of loose carbon granules as discussed above, US 2015/0217620 has proposed to embed such granules in a gas-permeable foam material. This has been achieved by introducing carbon granules into the foamed material prior to the foamed material being foamed. However, to embed sufficient carbon granules to mimic the behaviour of a pure carbon monolith, a very high fill factor would need to be achieved, perhaps 80% or more which, along with the foam skeleton would result in a part that was largely incompressible, with many of the pores masked during the process. Consequently, the carbon embedded foamed material will become incompressible and therefore unsuitable for use in the dynamic volume of an air spring. Furthermore, because no enabling method is disclosed, and such embedding with carbon grains would be difficult and expensive, this will cause increased complexity to the manufacturing process of an air spring.

The invention therefore aims to mitigate or eliminate one or more of the aforesaid disadvantages of the known art.

### SUMMARY OF THE INVENTION

In one aspect, the present invention provides an air spring for supporting a load, the air spring comprising: a chamber for holding a pressurised gas in use; a load bearing surface arranged to transmit a force from a load in use to the pressurised gas, and a block of gas permeable resilient material contained in the chamber.

As used herein the term “block of gas permeable resilient material” means a single body of springy matter which comprises an interconnected network of pores. These interconnected pores mean that one or more substantially free paths are formed through the material, which provides a conductive highway for heat transfer. Therefore, the block of gas permeable resilient material of the present invention is a heat sink material, and as such, acts a passive heat exchanger.

An effect arising from the use of a block of gas permeable resilient material of the present invention is that the spring rate of the pressured gas is reduced, which is particularly apparent when the air spring is operating in an adiabatic cycle (i.e. generally at an operational frequency of 1 Hz or greater). Therefore, the air spring of the present invention will preferably operate at frequencies of 1 Hz or greater, in use.

In more detail, pressurised gas at first temperature is absorbed by the block of gas permeable resilient material as a heat sink material during compression, and then transferred back during expansion at a second temperature, which is lower than that of the first temperature. Consequently, the net result is a reduction in spring rate because the air spring approaches a constant temperature or isothermal cycle. Therefore, in one aspect, the present invention provides the use of a block of gas permeable resilient material in an air spring to lower the spring rate, wherein the air spring is for supporting a load.

Furthermore, because the block of gas permeable material is resilient (i.e. springy) and therefore able to return to its original shape after bending and/or stretching and/or being compressed, the block of gas permeable resilient material is particularly useful in the dynamic volume of an air spring. This contrasts a rigid (i.e. non-springy) or incompressible material which would not be compatible in such an environment. Consequently, the spring rate in the dynamic volume may be reduced by the present invention.

The term “pressurised gas” as used herein means gas held at a pressure above atmospheric pressure. The term “air spring” as used herein means both air springs and gas struts.

Examples of air springs may be selected from rolling lobe air springs (both with or without pistons), convoluted air springs, and air springs used in bicycles (particularly mountain bikes) and motorcycles, such as gas struts.

A preferred block of gas permeable resilient material is porous matrix comprising an interconnected network of pores as discussed above. Preferably, such porous matrix is a composite material.

A highly preferred block of gas permeable resilient material is an open cell foam.

The term “foam” as used herein means an object comprising a cellular structure. Therefore, as well materials formed by trapping pockets of gas in a liquid or solid, the term “foam” also includes so called “digital foams” and “sponge” or “sponge-like” materials that comprise such a cellular structure. Furthermore, for the avoidance of any doubt, an “open cell foam” means a foam as described above that comprises an interconnected network of pores. It is this interconnectivity of the pores which provides such a material with permeability

The one or more open-cell foams of the present invention may be formed from one or more components such as polyethylene, polyester, polypropylene, polystyrene, polyurethane, polyamide, polychloroprene, poly vinyl chloride, silicone, and their respective copolymers, rubber, synthetic rubber, microcellular plastics, and melamine resins and the like. Methods for producing such open-cell foam will be apparent to those skilled in the art.

In one embodiment, the open cell foam and/or block of gas permeable resilient material has a porosity from about 70% to less than 100%, preferably from about 94% to less than 100%. It has been surprisingly found that at such porosities, the spring rate in an air spring is lowered.

In one embodiment, the open cell foam and/or block of gas permeable resilient material has a porosity from about 95% to about 99.9%.

Porosity is the volumetric fraction of pores in a material, and for the purposes of this disclosure is measured by comparing the weight of the skeletal material with the weight of the block.

In one embodiment, the open cell foam and/or block of gas permeable resilient material has an average pore size of 2 mm or less in diameter.

In one embodiment, the open cell foam and/or block of gas permeable resilient material has a cell count of about 10 or more pores per inch (ppi), and preferably, a cell count from about 10 ppi to about 300 ppi. The open cell foam and/or block of gas permeable resilient material may have a cell count of about 300 ppi or less, and more preferably about 200 ppi or less. In one embodiment, the open cell foam and/or block of gas permeable resilient material may have a cell count from about 60 ppi to about 300 ppi, preferably from about 60 ppi to about 200 ppi.

In one embodiment, the open cell foam and/or block of gas permeable resilient material has a modulus of elasticity of 1 MPa or less, preferably 150 kPa or less.

In one embodiment, the open cell foam and/or block of gas permeable resilient material is highly compressible, preferably with a maximal compression set of 30%. Compression set is a measure of the deformation (loss of initial height) of a material after it has been compressed under controlled temperature conditions for a set time. It is commonly expressed as a percentage of the material's original height.

Compression set as disclosed herein was determined by a sample of material, preferably open-cell foam, being compressed to about 50% of its original thickness, and then held in that fixed position at 70° C. for about 22 hours, or 23° C. for 72 hours.

In some embodiments of the present invention, the chamber, preferably a fixed volume chamber, further comprises a mass of adsorptive (adsorbent) material. In this embodiment, the block of gas permeable resilient material is preferably arranged as a barrier to the adsorptive material. Preferably, the block of gas permeable resilient material is elastically loaded and/or pressed against the adsorptive material. Advantageously, this prevents the adsorptive material from shuffling around, and generating powder in use. The barrier however still allows for fluid communication between the adsorptive material and the rest of the chamber.

The mass of adsorptive material may be a granular material. Preferably, the adsorptive material is activated carbon, and more preferably the adsorptive material is granular activated carbon.

A particular advantage of arranging the block of gas permeable resilient material as a barrier to the adsorptive material is that an adsorptive material may be used in an air spring without the risk of contamination to the air valve or air supply system. In particular, fine power initially present or generated in use from the adsorptive material is contained by the barrier and is thus prevented from entering the air valve or air supply system.

The term “barrier” therefore means that the adsorptive material is hindered or prevented from moving in a chamber or portion of the air spring.

Therefore, in one aspect, the present invention provides the use of a block of gas permeable resilient material as a barrier to an adsorptive (adsorbent) material in an air spring for supporting a load.

In one embodiment, the chamber of the air spring comprises a first portion volume that is dynamic in use, and a second portion volume that remains fixed in use. A preferred air spring of the present invention is a rolling lobe air spring.

In one embodiment, the second portion volume comprises a mass of adsorptive material, and the block of gas permeable resilient material is arranged as a barrier to the adsorptive material. As discussed herein, the block of gas permeable resilient material is preferably elastically loaded and/or pressed against the adsorptive material.

In one embodiment, the block of gas permeable resilient material is provided at an interface between the first portion volume and the second portion volume. In this configuration, the block of gas permeable resilient material is able to advantageously contain the adsorptive material to the second portion volume, as well as reduce the spring rate of the air spring in the first portion volume.

In one embodiment, the block of gas permeable resilient material is provided in a ring or in a frame at or adjacent an interface between the first portion volume and the second portion volume. Furthermore, the air spring may comprise attachment means to attach the block of gas permeable resilient material to a portion of the second portion volume and/or a portion of the first portion volume. Such means may also allow the gas permeable resilient material to be elastically loaded and/or pressed against the adsorptive material.

In one embodiment, the block of gas permeable resilient material is provided in the second portion volume and extends from the second portion volume into the first portion volume.

In the second portion volume, the block of gas permeable resilient material is preferably elastically loaded or pressed against the adsorptive material to stop it from shuffling and generating powder in use. Therefore, means to provide such loading or pressure may provide in some embodiments.

In one embodiment, a mass of adsorptive material is provided in the second portion volume, and the block of gas permeable resilient material is provided in the first portion volume and/or the second portion volume, and in which the block of gas permeable resilient material occupies the first portion volume from greater than 0 to 100% of the design of the first portion volume.

In one embodiment, the block of gas permeable resilient material is provided in the first portion volume. In the first portion volume, the block of gas permeable resilient material may be provided as one more or more separate blocks of material. Preferably two or more, or even three or more, separate blocks of gas permeable resilient material may be provided in the first portion volume.

Advantageously, the use of one or more blocks of gas permeable resilient material in the first portion volume will not only act to reduce the spring rate of the air spring in the first portion volume, but in some embodiments, such use may also provide the block as a filter, to filter fluid (such as air or nitrogen) entering the first portion volume 52, for example through a bead plate. Therefore, in some embodiments the pore size of one or more block of gas permeable resilient material in the first portion volume may be tuned to provide such filtering. The one or more blocks of gas permeable resilient material in the first portion volume may therefore be position over a fluid inlet, such as an opening in the bead plate. In some embodiments, where two or more separate blocks of separate blocks of gas permeable resilient material are provided in the first portion volume, the pore size of one block may have a finer (smaller) pore size that of a further block.

Furthermore, by providing multiple blocks of gas permeable resilient material in the first portion volume, a higher fill factor can be achieved without causing interstitial stress within the gas permeable member that might cause fissures or tears.

The shape of the blocks is typically of no defined shape, but example shapes may include regular or irregular square blocks, rectangular blocks, circular blocks, 3-D cuboid blocks, and cylindrical blocks. Shapes that have smoothed corners may be preferred, and some blocks may comprise a mushroom head shape. In particular, the shape will be selected according the desired level of fill in the second portion volume.

In a highly preferred embodiment, the block of gas permeable resilient material in the first portion volume cannot contact the walls of the first portion volume as the air spring is in use. This is because such walls are typically thin delicate membranes and any friction from rubbing may result in damage such as tears, which may result in leaks in the air spring. Therefore, the block of gas permeable resilient material of the present invention can be shaped or moulded in a way to prevent such contact during the compression and expansion of the air spring.

In one embodiment, the block of gas permeable resilient material occupies the first portion volume from greater than about 0 to about 100% of the design volume of the first portion volume.

In one embodiment, the block of gas permeable resilient material occupies the first portion volume from greater than about 25 to about 100% of the design volume of the first portion volume.

Preferably, the block of gas permeable resilient material substantially fills the first portion volume (i.e. it occupies about 100% of the design volume of the first portion volume).

In one embodiment, a wall extends across an interface between the first portion volume and the second portion volume. This provides a restriction to the flow of fluid between the first portion volume and the second portion volume. Preferably, the wall comprises one or more orifices. Such orifices allow fluid flow between the first portion volume and the second portion volume.

In one embodiment, the one or more offices may also include a flexible flap which may extend over and partially occlude such orifices. The use of a flexible flap allows an orifice to become larger and/or smaller when subjected to different flow rates of fluid.

In one embodiment, a mass of adsorptive material is provided at one side of the wall in the second portion volume, and the block of gas permeable resilient material is provided at the other or both sides of the wall. For the avoidance of any doubt, the “wall” in this regard refers to the wall comprising the one or more orifices that extends across an interface between the first portion volume and the second portion volume. The “other side of the wall” means such wall in the first portion volume. Preferably, the block of gas permeable resilient material occupies the first portion volume from greater than 0 to 100% of the design of the first portion volume. More preferably, the block of gas permeable resilient material occupies the first portion volume from greater than 25 to 100% of the design of the first portion volume.

In one embodiment, the block of gas permeable resilient material is provided at both sides of the wall, and the block of gas permeable resilient material is preferably pressed against the adsorptive material in the second portion volume.

In one embodiment, the block of gas permeable resilient material is disposed at one and/or both sides of the wall. Further, the block of gas permeable resilient material may be disposed as a plug in and/or around the one or more orifices of the wall.

In some embodiments, a gauze, a mesh, and/or a filter may be provided between the adsorptive material and the block of gas permeable resilient material.

In one aspect, an air suspension system comprising an air spring according to the present invention is provided. Such systems include those typically found on vehicles as well as air suspension systems for seating.

In one aspect, a vehicle comprising an air spring according to the present invention and/or an air suspension system according to the present invention is provided. The vehicle may be selected from a motor vehicle; a commercial vehicle; an electric vehicle; a railed vehicle; aircraft; and bicycles. Preferably, the vehicle is an electric vehicle.

The air spring of the present invention may also be used in commercial vehicle applications, (such as mountings used in taxis) as well as machine isolators and seismic isolators. The air spring of the present invention may also include air springs used in bicycles (particularly those used in mountain bikes) and motorcycles.

In another aspect, the present invention provides an air spring for supporting a load, the air spring comprising: a chamber for holding a pressurised gas in use; a load bearing surface arranged to transmit a force from a load in use to the pressurised gas, a block of gas permeable resilient material contained in the chamber, and in which the chamber comprises a mass of adsorptive material. In this embodiment, the block of gas permeable resilient material is preferably arranged as a barrier to the adsorptive material as discussed above. Therefore, in another aspect, the present invention preferably provides the use of a block of gas permeable resilient material as a barrier to an adsorptive (adsorbent) material in an air spring for supporting a load.

### BRIEF DESCRIPTION OF THE DRAWINGS

For a better understanding of the invention, and to show how example embodiments may be carried into effect, reference will now be made to the accompanying drawings in which:

FIG. 1 is a cross-section of an air spring according to a first embodiment of the invention;

FIG. 2 is a cross-section of an air spring according to a second embodiment of the invention;

FIG. 3 is a cross-section of an air spring according to a third embodiment of the invention;

FIG. 4 is a graph showing the results of an experiment to determine the spring rate of an air spring of the present invention;

FIG. 5 is a cross-section of an air spring according to a fourth embodiment of the invention;

FIG. 6 is a cut-away view from FIG. 5;

FIG. 7 is a graph showing the results of an experiment to determine the spring rate of an air spring of the present invention which comprises internal damping means; and

FIG. 8 is a graph showing the results of experiment 3.

### DETAILED DESCRIPTION OF THE EXAMPLE EMBODIMENTS

Several embodiments of the invention are now described.

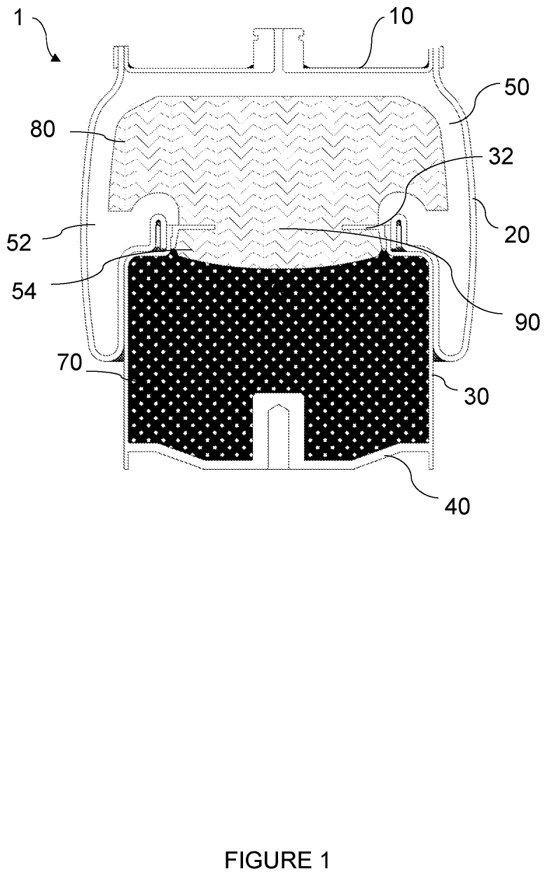

Referring to FIG. 1, an air spring 1 for supporting a load is provided which is a reversible sleeve or rolling robe air spring. The air spring 1 comprises an upper bead plate 10, a bellows 20 and a piston 30 having a lower surface (for ease of description called a lower bead plate 40 herein), as would be known to the normal designer of air springs. The bellows 20 may be made from a flexible material such as rubber or the like. Said material is sufficiently inelastic to maintain substance substantially the same volume variation with length as the pressure in the piston 30 is varied. The bellows comprise a first end connected to the upper bead plate 10 and a second end connected to the lower bead plate 40 for sealing the chamber 50.

The air spring comprises a chamber 50 that is defined by the upper bead plate 10, the bellows 20 and the piston 30, and normally holds a pressurised gas P1 (not shown) to support a load in use. An air inlet (not shown) is often used to connect a source of pressurised gas or an exhaust to the chamber 50 so that the internal pressure of the chamber and height of the air spring may be controlled. As discussed above, one advantage of an air spring is that its height can be adjusted to suit a particular application or need. A load (not shown) is usually attached to one of the upper bead plate 10 or the lower bead plate 40 via respective mounting plates (not shown). One or more of these plates act as load bearing surfaces that are arranged to transmit a force from a load in use to the pressurised gas (P1). The piston 30 including one or more load bearing plates 40 on a first outward side of said piston 30 for receiving a load and wherein a second inboard face is in contact with in the pressurised gas P1 for transmitting the load thereto. The upper bead plate 10 comprising one or more load bearing plates on a first outward side of said bead plate 10 for receiving a load and wherein the second inboard face is in contact with in the pressurised gas P1 for transmitting the load thereto.

As shown, a block of gas permeable resilient material 80 is contained in the chamber 50. Such material lowers the spring rate of the air spring by acting as a heat sink in use. Preferably this material is an open-cell foam material. A preferred porosity is from about 70% to less than 100%.

As also shown, the chamber further comprises a mass of adsorptive material 70. Preferably, this material is activated carbon in granular form. Such a material also lowers the spring rate of the air spring in use by adsorption/desorption.

Advantageously, in this embodiment, the gas permeable resilient material 80 is arranged to provide a barrier to the adsorptive material 70. This means that the adsorptive material 70 is hindered or prevented from moving in a chamber of the air spring 1. It is preferable that in some embodiments the gas permeable resilient material 80 is elastically loaded or pressed against the adsorptive material 70. Therefore, optional mechanical means (not shown) may be provided to assist in exerting mechanical pressure on the adsorptive material 70, which advantageously stops the adsorptive material 70 from moving and generating powder in use. Consequently, the air supply lines are prevented from becoming clogged by any loose adsorptive material. Such an arrangement is particularly effective if the adsorptive material is a loose granular material. Typically, the gas permeable resilient material 80 is compressed against the adsorptive material 70 to further restrict its movement. Furthermore, as shown, the gas permeable resilient material 80 is positioned in the air spring to avoid contact with the bellows 20, which therefore avoids damage to such bellows 20 during the compression and expansion stages in use.

As shown by FIG. 1, the air spring chamber 50 preferably comprises a first portion volume 52 and a second portion volume 54. Such a first portion volume 52 is generally within the bellows 20 and has a volume which changes in use (i.e. a dynamic volume). The second portion volume 54 is generally within the piston 30 and has a fixed volume in use.

An interface 90 is also provided between the first portion volume 52 and the second portion volume 54, and the interface 90 may intersect with an outer wall 32 of the second portion volume (i.e. the head of the piston 30).

The second portion volume 54 comprises the adsorptive material 70. Furthermore, the block of block of gas permeable resilient material 80 is provided at the interface 90 between the first portion volume 52 and the second portion volume 54. Such an arrangement helps to contain the adsorptive material 70 to the second portion volume 54. As such, in this configuration, the gas permeable resilient material 80 is able to advantageously contain the adsorptive material 70 to the second portion volume 54 (i.e. the piston) as well as reduce the spring rate of the air spring in the first portion volume 52,

As also shown, the block of gas permeable resilient material 80 is provided in the second portion volume 54 and extends from the second portion volume 54 into the first portion volume 52. Furthermore, the block of gas permeable resilient material 80 is provided in the first portion volume 52 and substantially fills the first portion volume 52. The gas permeable resilient material 80 is shown to comprise a mushroom head shape in the first portion volume 54.

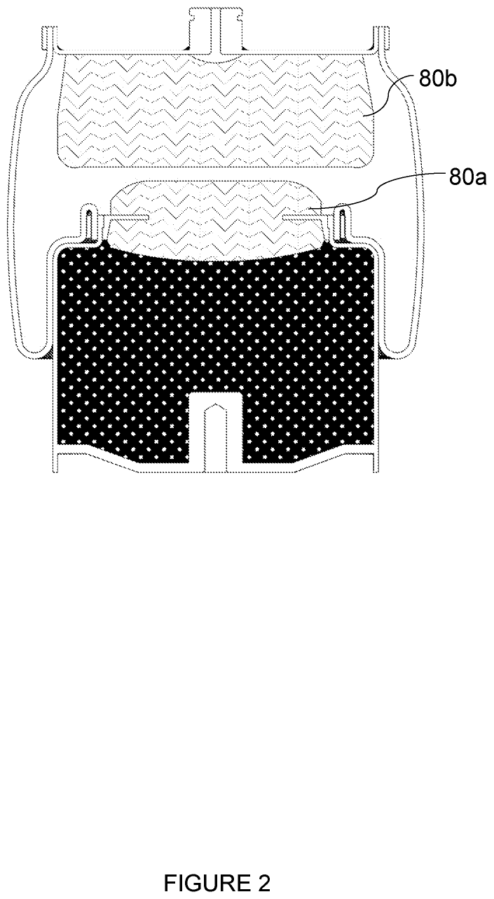

FIG. 2 shows a similar air spring with a similar working configuration to FIG. 1 but with a first block of gas permeable resilient material 80a provided at an interface 90 between the first portion volume 52 and the second portion volume 54, and a second block of gas permeable resilient material 80b provided in the first portion volume 52. As such, the second block of gas permeable resilient material may act as an air filter to air lines entering the first portion volume 52, for example through the bead plate 10. Therefore, in some embodiments, the second block 80b may have a finer (smaller) pore size than that of the first block 80a, and may be positioned over a fluid inlet. Of course, the second block 80b will also act as reduce the spring rate of the air spring in the first portion volume 52, as per the first block 80a.

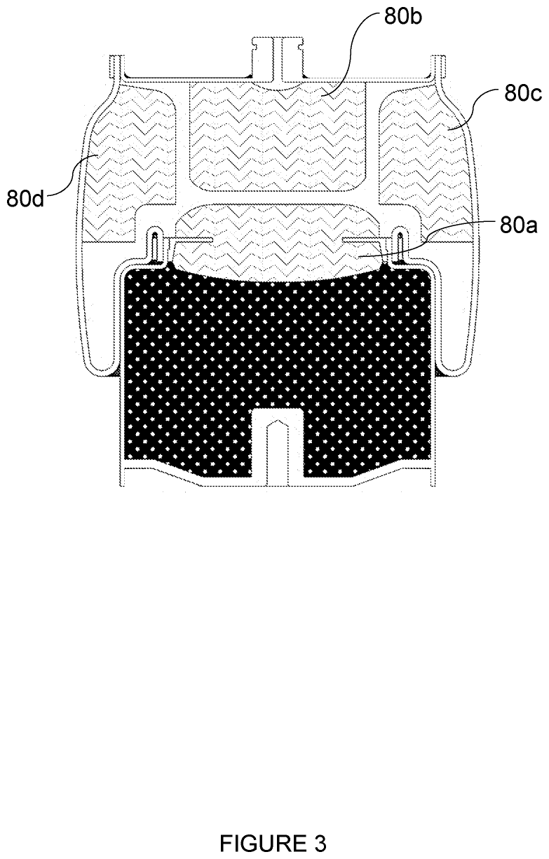

FIG. 3 shows a similar air spring with a similar working configuration to FIG. 1, but with a first block of gas permeable resilient material 80a provided at an interface 90 between the first portion volume 52, and multiple blocks of gas permeable resilient material 80b, 80c, 80d provided in the first portion volume 52. As shown, the portion 80c is provided at an opposite side to that of the portion 80d in the first portion volume 52, and has a shape of symmetrical symmetry. By providing multiple blocks of gas permeable resilient material in the first portion volume 52, a higher fill factor can be achieved without causing interstitial stress within the gas permeable member that might cause fissures or tears.

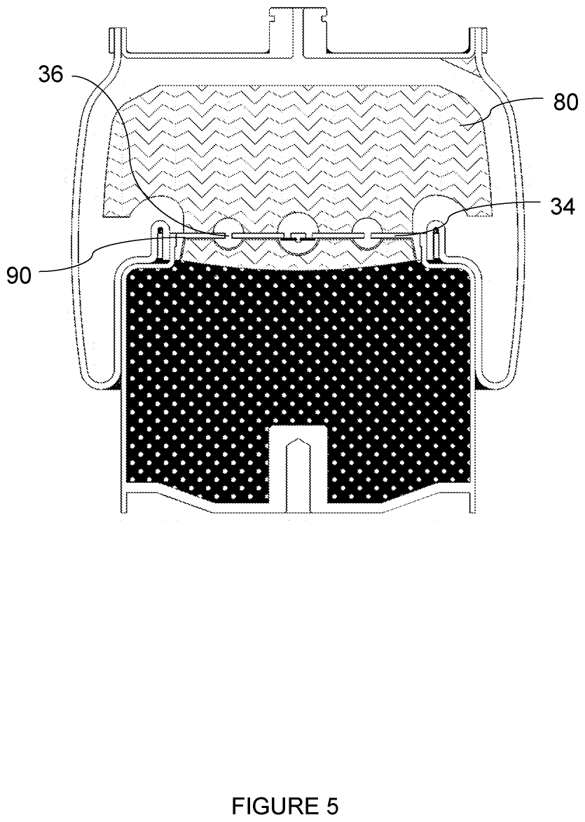

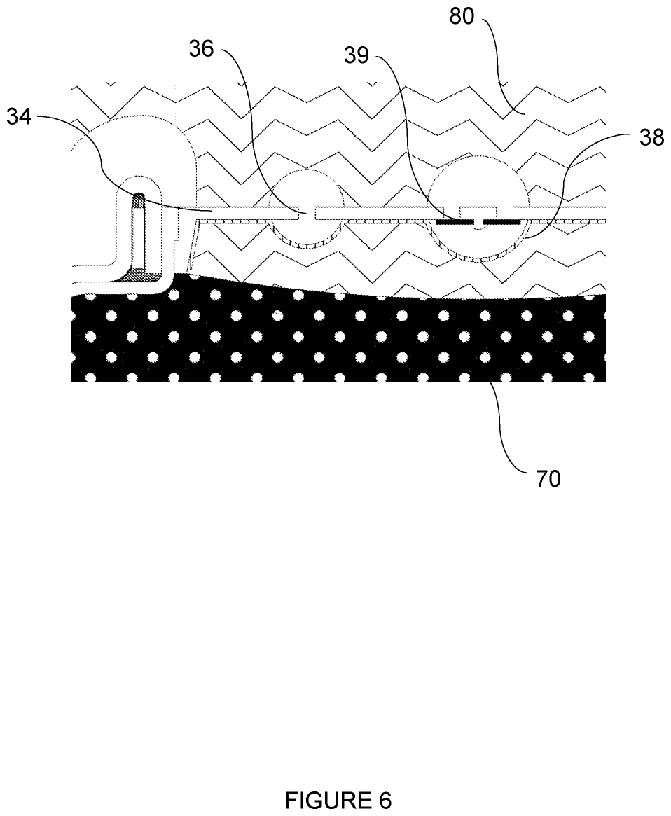

FIG. 5 shows a similar working configuration to FIG. 1, and FIG. 6 shows an enlarged section of FIG. 5. The block of gas permeable resilient material 80 is provided at the interface 90 between the first portion volume 52 and the second portion volume 54

Best shown from FIG. 6, a lid or wall 34 extends across the interface 90 between the first portion volume 52 and the second portion volume 54. The wall 34 comprises one or more orifices 36 to allow fluid communication from the first portion volume 52 to the second portion volume 54. This arrangement allows for the air spring to comprise internal damping because the wall 34 together with one or more narrow orifices 36 restrict the air flow between the first portion volume 52 and the second portion volume 54. For optimal damping, the diameter of the one or more orifices 36 may be tuned using a flap 39 that is preferably provided across the one or more orifices 36.

As shown, a mass of adsorptive material 70 is provided at one side of the wall 34 in the second portion volume 54, and the block of gas permeable resilient material 80 is provided at the other side of the wall in the first portion volume 52. In this embodiment, the block of gas permeable resilient material is also provided in the second portion volume 54 and is arranged as a barrier to the adsorptive material 70. More particularly, the block of gas permeable resilient material 80 is provided between the wall 34 and the adsorptive material 70 in the second portion volume 54, and is elastically loaded or pressed against the adsorptive material 70 in the second portion volume 54.

As shown in this embodiment, the block of gas permeable resilient material 80 is further disposed at both sides of the wall 34 and around the one or more orifices 36 of the wall 34.

In this embodiment, a gauze, and/or a mesh, and/or a filter 38 is also provided between the block of gas permeable resilient material 80 and the adsorptive material 70.

Conveniently, the gas permeable resilient material 80 in this embodiment is also provided in a ring or in a frame at or adjacent an interface between the first portion volume 52 and the second portion volume 54. Attachment means (not shown) may also be provided to attach the block of gas permeable resilient material 80 to a portion of the second portion volume 54 and/or a portion of the first portion volume 52 and/or the wall 34.

### EXPERIMENTAL SECTION

### Experiment 1

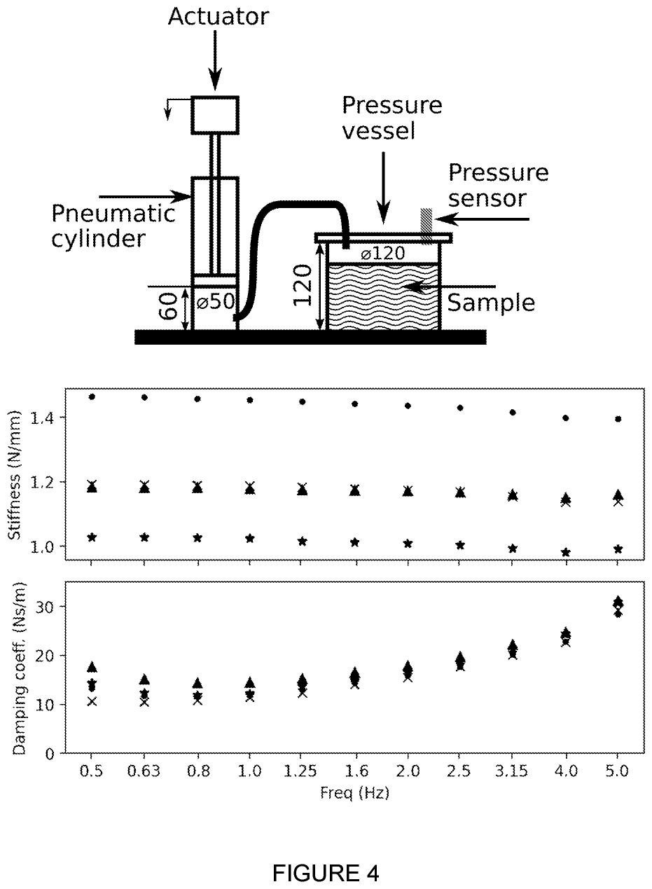

A pneumatic cylinder with a piston diameter of 50 mm was connected to an external vessel of 1.36 L, which contained the sample under test. The setup is shown in the diagram in FIG. 4. The system was pressurised to 3 bar, and the actuator was excited with a sinusoidal input with a frequency range of 0.5-5 Hz and 20 mm peak to peak amplitude. The displacement of the piston and the pressure in the external vessel were measured, and the complex air cavity stiffness k* was obtained in the frequency domain from the ratio of pressure to displacement at the excitation frequencies:

$${k}^{*} = A \frac{P}{x}$$

The damping coefficient c was obtained from the imaginary part of the complex stiffness:

$$c = \frac{I ( {k}^{*} )}{ω}$$

The results of experiment 1 are shown in FIG. 4 which illustrates a graph of spring rate improvement using activated carbon (Cabot Norit GCN3070) and open-cell melamine foam (9.5 kg/m³ density and 99.4% porosity) in the test vessel.

The stiffness of the air alone in the vessel is shown by dot markers. The stiffness of the cavity when 100% occupied by melamine foam is shown by the cross markers. The triangular markers show the stiffness of the air chamber when occupied with 100 g of activated carbon, representing around 14% of the cavity volume. In both cases, stiffness is reduced by around 19%. The star markers show air stiffness when the 100 g of carbon occupies 14% of the cavity, and melamine foam occupies the rest of the vessel; stiffness is reduced by around 30%. The experiment demonstrates that an open-cell foam can be used to reduce the spring rate in a chamber comprising pressurised gas.

### Experiment 2

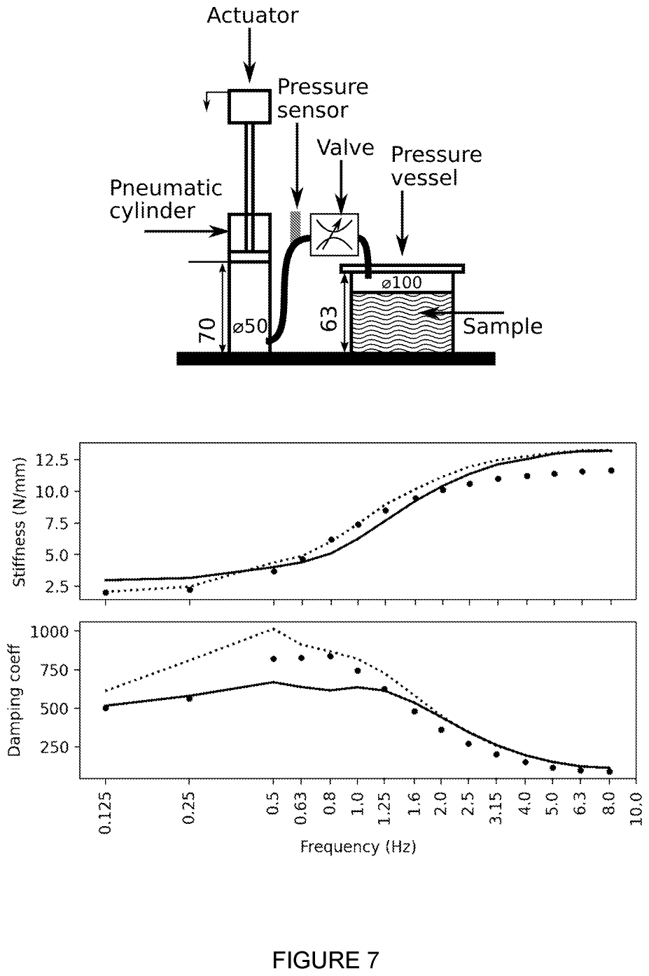

A pneumatic cylinder with a piston diameter of 50 mm (acting as a primary chamber of 140 ml volume) was connected to an external vessel (the secondary chamber) of 495 ml through a flow valve, to act as an adjustable damping orifice. The system is illustrated in FIG. 7, and was pressurised to 3 bar, and the actuator was excited with a sinusoidal input with a frequency range of 0.125-8 Hz and 16 mm peak to peak amplitude (6 mm amplitude at 8 Hz).

The flow valve was manually adjusted at the beginning of the experiment to shift the location of the transition region between low and high stiffness to the frequency range of interest. The valve then remained at the same setting through all tests. The samples under test were placed in the external (secondary) chamber.

The displacement of the piston and the pressure before the flow valve (on the pneumatic cylinder side) were measured, and the complex air cavity stiffness k* was obtained in the frequency domain from the ratio of pressure to displacement at the excitation frequencies:

$${k}^{*} = A \frac{P}{x}$$

The damping coefficient c was obtained from the imaginary part of the complex stiffness:

$$c = \frac{I ( {k}^{*} )}{ω}$$

The graph in FIG. 7 shows the result of the experiment. In this experiment, activated carbon (Cabot Norit GCN3070) and open-cell melamine foam (9.5 kg/m³ density and 99.4% porosity) was used.

The solid line in black shows the results for air alone in both chambers. The damping coefficient (lower graph) reaches a maximum at 0.8 Hz before gradually tailing off, as less air passes into the secondary chamber through the damping orifice with rising frequency of actuation. The stiffness curve (above) reflects this, with stiffness rising in the pneumatic cylinder as the secondary chamber becomes more occluded with rising frequency.

The fine dotted line shows the effect of filling the secondary chamber with activated carbon. The damping coefficient rises significantly and reaches a peak at a slightly lower frequency (0.5 Hz), though the range of high damping levels is much greater than when air is in the chamber. There is a slight commensurate lowering of stiffness at very low frequencies (below 0.5 Hz), but both damping and system stiffness approach similar levels to the empty case at higher frequencies as the secondary chamber is occluded.

The large dotted markers show what happens when melamine foam is added to the pneumatic cylinder cavity, while activated carbon still occupies the secondary chamber. Damping levels are still elevated over the case where air is used in both chambers, but now stiffness is reduced at higher frequencies, increasing vibration isolation at all frequencies.

### Experiment 3

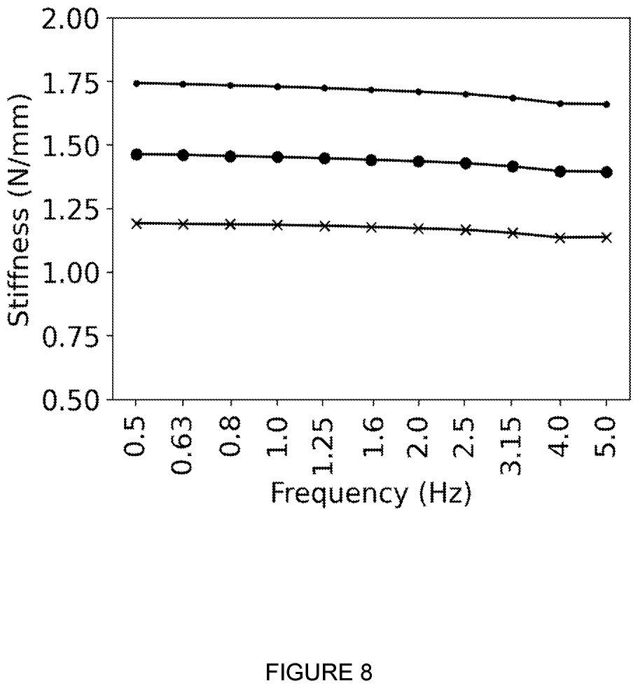

This experiment follows the same procedure as Experiment 1. The plotted result in FIG. 8 includes the modelled cavity stiffness for a foam of low porosity (60%), below the 70% threshold, shown by small dotted markers. The stiffness of the air alone in the vessel is shown by large dotted markers. The stiffness of the cavity when 100% occupied by melamine foam is shown by the cross markers.

The modelled low porosity foam stiffness is obtained by knowing that the low frequency limit of acoustic bulk modulus of air in an open-cell porous material Ks for small displacements is (as disclosed by Allard & N. Atalla, Propagation of Sound in Porous Media, John Wiley & Sons 2009):

$${K}_{f} = \frac{{P}_{0}}{ϕ}$$

Where ¢ is the porosity of the foam and P₀ the equilibrium pressure. The bulk modulus of air at low frequency is also known:

$${K}_{air} = γ {P}_{0}$$

Where γ is the adiabatic index (1.4 in this case). The total cavity stiffness of an air cylinder, kₐᵢᵣ in N/m, (for small displacements) for air alone will be:

$${k}_{a i r} = \frac{{A}^{2} {K}_{a i r}}{V}$$

Where A is the surface area of the piston, and V the cavity volume. For a piston filled with foam of any porosity, the stiffness k_{f} can be obtained relative to the bulk modulus of air alone, since

$${K}_{f} = \frac{{P}_{0}}{ϕ} = \frac{{K}_{air}}{γ ϕ} :$$

$${k}_{f} = \frac{{A}^{2} {K}_{a i r}}{V γ ϕ}$$

This equation shows that the stiffness of a cavity with foam will be higher than air if the foam porosity is lower than 1/γ, or around 70% for nitrogen or air. Assuming the same volume and piston area, the modelled stiffness for an arbitrary foam can be obtained from the measured stiffness of air kₐᵢᵣ:

$${k}_{f} = \frac{{k}_{a i r}}{γ ϕ}$$

1. An air spring for supporting a load, the air spring comprising: a chamber for holding a pressurised gas (P1) in use; a load bearing surface arranged to transmit a force from a load in use to the pressurised gas (P1); a block of gas permeable resilient material contained in the chamber, and in which the block of gas permeable resilient material has a porosity from about 70% to less than 100%.

2. The air spring according to claim 1, in which the block of gas permeable resilient material is an open cell foam.

3. The air spring according to claim 1, in which the block of gas permeable resilient material has a porosity from about 95% to about 99.9%.

4. The air spring according to claim 2, in which the block of gas permeable resilient material has an average pore size of about 2 mm or less in diameter, or about 10 or more pores per inch.

5. The air spring according to claim 2, in which the block of gas permeable resilient material has a modulus of elasticity of about 1 MPa or less, or about 150 kPa or less.

6. The air spring according to claim 1, in which the chamber comprises a first portion volume that is dynamic in use and a second portion volume that remains fixed in use.

7. The air spring according to claim 6, in which the second portion volume comprises a mass of adsorptive material, or in which the block of gas permeable resilient material is a barrier for containing the adsorptive material within the second portion volume.

8. The air spring according to claim 7, in which the block of gas permeable resilient material is provided at an interface between the first portion volume and the second portion volume, or in which the block of gas permeable resilient material is elastically loaded or pressed against the adsorptive material in the second portion volume.

9. The air spring according to claim 7, in which the block of gas permeable resilient material is provided in a ring or in a frame at or adjacent an interface between the first portion volume and the second portion volume, or in which the block of gas permeable resilient material is provided with attachment means to attach the block of gas permeable resilient material to a portion of the second portion volume and/or a portion of the first portion volume.

10. The air spring according to claim 7, in which the block of gas permeable resilient material is provided in the second portion volume and extends from the second portion volume into the first portion volume.

11. The air spring according to claim 6, in which the block of gas permeable resilient material is provided in the first portion volume.

12. The air spring according to claim 6, in which the block of gas permeable resilient material occupies the first portion volume from greater than 0 to 100% of the design of the first portion volume.

13. The air spring according to claim 12, in which the block of gas permeable resilient material-substantially fills the first portion volume.

14. The air spring according to claim 6, in which a wall extends across an interface between the first portion volume and the second portion volume, and in which the wall comprises one or more orifices for restricting the flow of fluid between the first portion volume and the second portion volume.

15. The air spring according to claim 14, in which a mass of adsorptive material is provided at one side of the wall in the second portion volume, and the block of gas permeable resilient material is provided at the other or both sides of the wall, and in which the block of gas permeable resilient material occupies the first portion volume from greater than 25 to 100% of the design of the first portion volume.

16. The air spring according to claim 15, in which the block of gas permeable resilient material is provided at both sides of the wall, and is elastically loaded or pressed against the adsorptive material in the second portion volume.

17. The air spring according to claim 7, in which the adsorptive material is a granular material, or a granular activated carbon material.

18. A vehicle comprising an air spring according to claim 1.

19. A method of lowering the spring rate in an air spring comprising providing a block of gas permeable resilient material in the air spring, wherein the air spring is for supporting a load, and in which the block of gas permeable resilient material has a porosity from about 70% to less than 100%.
